(19) United States
(12) Patent Application Publication
(10) Pub. No.: US 2015/0207923 A1
(43) Pub. Date: Jul. 23, 2015

(54) METHOD, TERMINAL AND COMPUTER STORAGE MEDIUM FOR TRIGGERING A COMMUNICATION WITH A CONTACT

(71) Applicants: Yangchao Zhang, Shenzhen City (CN); Jing He, Shenzhen City (CN); Yu Chen, Shenzhen City (CN); Bin Li, Shenzhen City (CN); Kaiyuan Lv, Shenzhen City (CN)

(72) Inventors: Yangchao Zhang, Shenzhen City (CN); Jing He, Shenzhen City (CN); Yu Chen, Shenzhen City (CN); Bin Li, Shenzhen City (CN); Kaiyuan Lv, Shenzhen City (CN)

(21) Appl. No.: 14/379,817

(22) PCT Filed: Dec. 26, 2013
(86) PCT No.: PCT/CN2013/090528

§ 371 Date: Aug. 20, 2014

(30) Foreign Application Priority Data
May 8, 2013 (CN) 201310167859.7

(51) Int. Cl. H04M 1/725; H04W 4/12; H04M 3/44; G06F 3/0484

(52) U.S. Cl. CPC H04M 1/72583; G06F 3/0484; H04W 4/12; H04M 3/44

(57) ABSTRACT

Provided is a method for triggering a communication with a contact, the method obtaining sliding track data generated by actions on a contact button in the contact list. Then, identifying a direction of sliding track according to the sliding track data. When the direction of the slide track is determined, then triggering a corresponding operating instruction according to the direction of sliding track; wherein, when it is determined that the slide track is in a first direction the operating instruction is to call the contact's contact number and when the slide direction is in a second direction the operating instruction is a short message instruction for sending a short message to the contact's number.

### CROSS-REFERENCE TO RELATED APPLICATIONS

This application is a U.S. National Phase application submitted under 35 U.S.C. §371 of Patent Cooperation Treaty application serial no. PCT/CN2013/090528, filed Dec. 26, 2013, and entitled METHOD, TERMINAL AND COMPUTER STORAGE MEDIUM FOR TRIGGERING A COMMUNICATION WITH A CONTACT, which application claims priority to Chinese patent application serial no. 201310167859.7, filed May 8, 2013, and entitled

[symbol]

, which are incorporated herein by reference.

### TECHNICAL FIELD

The present disclosure relates to the field of mobile communication, and more particularly to a method, a device and a computer storage medium for triggering a communication with a contact.

### BACKGROUND

Along with the popularity of smart mobile terminals, it has played a significant role in people's daily life to communicate with contacts listed in an address book through a mobile terminal, such as to dial a phone call, to send a short message, and so on. The conventional method for triggering a communication with a contact comprises following steps: accessing the address book, locating the corresponding contact in the address book, clicking the corresponding contact and accessing to the interface of contact details. Then, if the user intends to dial a phone call, the user triggers the dialing function by means of pressing the dialing button located in the interface of contact details; if the user intends to send a short message, the user triggers the editing function for short message by means of pressing the short message button located in the interface of contact details.

In the process of dialing a phone call or sending a short message, the user needs to click the contact to access to the interface of contact details, and then needs to click different buttons for realizing the function of dialing a phone call or the function of sending a short message, which is complicated to operate. Especially, it is more inconvenient when operating in a mobile terminal with a touch screen, as a result, the time of the user in operating the mobile terminal is increased, and the duration time of a mobile terminal with limited power is shortened.

### SUMMARY

In view of the defects existing in the prior art mentioned above, in one aspect, the present disclosure provides a method for triggering a communication with a contact, which can achieve dialing a phone call or sending a short message quickly, so as to prolong the duration time of a mobile terminal.

A method for triggering a communication with a contact, comprising: obtaining sliding track data generated by actions on the contact button in the contact list by a mobile terminal; identifying direction of sliding track according to said sliding track data by said mobile terminal; triggering corresponding operating instruction according to said direction of sliding track by said mobile terminal; wherein, said operating instruction includes a dialing instruction for making a phone call to the contact and/or a short message instruction for sending a short message to the contact.

In another aspect, the present disclosure provides a device for triggering a communication with a contact, comprising: a track obtaining module, configured to obtain sliding track data generated by actions on the contact button in the contact list; a track identifying module, configured to identify direction of sliding track according to said sliding track data; an instruction triggering module, configured to trigger corresponding operating instruction according to the direction of sliding track; wherein, said operating instruction includes a dialing instruction for making a phone call to the contact and/or a short message instruction for sending a short message to the contact.

In another aspect, the present disclosure provides a computer storage medium for executing a method for triggering a communication with a contact, wherein, the method includes:
obtaining sliding track data generated by actions on a contact button in contact list by a mobile terminal;
identifying direction of sliding track according to said sliding track data by said mobile terminal;
triggering corresponding operating instruction according to said direction of sliding track by said mobile terminal;
wherein said operating instruction includes a dialing instruction for making a phone call to the contact and/or a short message instruction for sending a short message to the contact. According to the method, device and the computer storage medium for triggering a communication with a contact of the present disclosure, the direction of sliding track is identified by obtaining sliding track data generated by actions on the contact button in the contact list, then different operating instructions are triggered according to the direction of sliding track, whereby, the user can achieve dialing a phone call or sending a short message quickly, which simplifies the operations and shortens the user's time in operating the mobile terminal, and prolongs the duration time of the mobile terminal.

### BRIEF DESCRIPTION OF THE DRAWINGS

FIG. 1 is a schematic flow diagram illustrating the method for triggering a communication with a contact according to one embodiment of the present invention;

FIG. 2 is a schematic flow diagram illustrating the method for triggering a communication with a contact according to another embodiment of the present invention;

FIG. 3 is a schematic diagram illustrating the operations for triggering a communication with a contact in the embodiment as shown in FIG. 2;

FIG. 4 is a schematic flow diagram illustrating the method for triggering a communication with a contact according to another embodiment of the present invention;

FIG. 5 is a structure diagram illustrating the device for triggering a communication with a contact according to one embodiment of the present invention;

FIG. 6 is a structure diagram illustrating the device for triggering a communication with a contact according to another embodiment of the present invention;

FIG. 7 is a structure diagram illustrating the device for triggering a communication with a contact according to another embodiment of the present invention;

FIG. 8 is a structure diagram illustrating the device for triggering a communication with a contact according to another embodiment of the present invention.

### DETAILED DESCRIPTION

In order to make the purpose, technical solutions and advantages of the present disclosure to be understood more clearly, the present disclosure will be described in further details with the accompanying drawings and the following embodiments. It should be understood that the specific embodiments described herein are merely examples to illustrate the disclosure, not to limit the present disclosure.

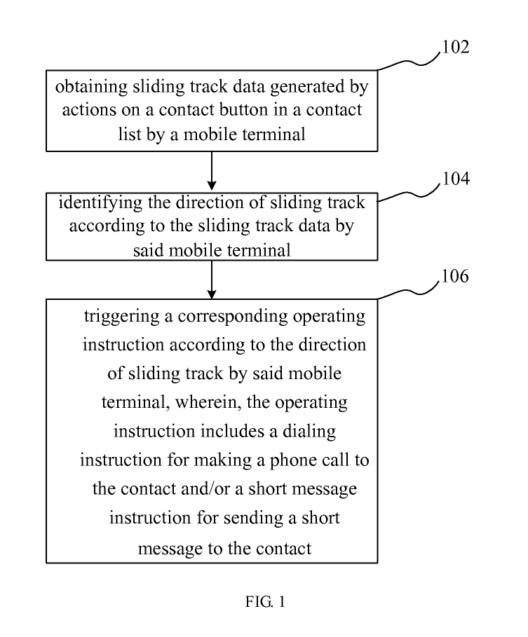

As shown in FIG. 1, in one embodiment, a method is provided for triggering a communication with a contact, which is illustrated by implementing the method in a mobile terminal that has a communicating function and contains a touch screen or a touch pad. The method includes following steps:

Step 102: obtaining sliding track data generated by actions on a contact button in a contact list by a mobile terminal.

Taking the mobile terminal containing a touch screen as an example, the mobile terminal saves contact information, and the contact information contains the mobile contact number, fixed telephone number, name, and address of contacts. The contact list can be displayed in the address book, it is possible to access to the interface of contact details by means of clicking a certain contact in the contact list, and the information of the contact will be displayed in the interface of contact details.

The mobile terminal detects the triggering signal, which is generated by actions on a contact button in the contact list, wherein the triggering signal may be a signal triggered by the touching operation in the touch screen by a user's finger. In this embodiment, the mobile terminal detects the sliding signal generated by actions on the contact button in the contact list, so as to obtain the sliding track data, which include multiple coordinate data aligned at intervals in the sliding track. Such that, the sliding track data generated by actions on a contact button in the contact list which are detected by the mobile terminal are obtained.

Step 104: identifying the direction of sliding track according to the sliding track data by said mobile terminal.

The direction of sliding track can be identified through the coordinate data contained in the sliding track data, such as the direction of sliding to the left or the direction of sliding to the right, and so on.

Step 106: triggering a corresponding operating instruction according to the direction of sliding track by said mobile terminal, wherein, the operating instruction includes a dialing instruction for making a phone call to the contact and/or a short message instruction for sending a short message to the contact.

In this embodiment, the corresponding relationship between the direction of sliding track and the operating instruction can be pre-set, for instance, sliding to the left is set to correspond to the dialing instruction, and sliding to the right is set to correspond to the short message instruction.

In one embodiment, the step 106 includes the following steps: if the direction of sliding track is in the first direction, then triggering the dialing instruction for making a phone call to the contact corresponding to the first direction by said mobile terminal; if the direction of sliding track is in the second direction, then triggering the short message instruction for sending a short message to the contact corresponding to the second direction by said mobile terminal; wherein, the first direction is opposite to the second direction. In this embodiment, it is possible to distinguish the dialing instruction and the short message instruction through the direction of sliding track, if the dialing instruction is triggered, then dialing the contact number of the contact directly, and if the short message instruction is triggered, then accessing to the short message editing interface of the contact.

In this embodiment, different operating instructions with respect to the contact are triggered through directions of sliding track, whereby dialing a phone call or sending a short message can be triggered quickly, so as to achieve quick dialing a phone call or quick sending a short message. The method of the present disclosure can simplify operations as compared to the conventional method of multiple clicking operations, especially for the mobile terminal with a touch screen, the use of the method of the present disclosure will reduce the user's time in operating the mobile terminal, whereby the duration time of the mobile terminal is prolonged. Moreover, since the operating system of the mobile terminal with a touch screen can detect from the touch screen itself the sliding track data generated by actions on the contact button, by obtaining the sliding track data directly, the step of detecting the sliding track data can be omitted, and the processing efficiency is improved.

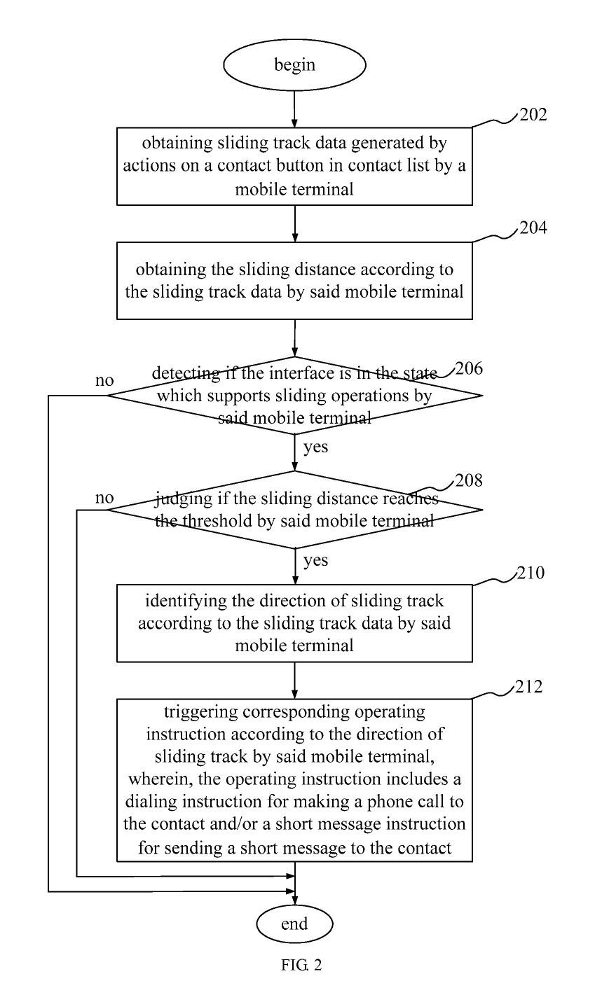

As shown in FIG. 2, in this embodiment, another method is provided for triggering a communication with a contact, which is also illustrated by implementing the method in the mobile terminal which has a communicating function and contains a touch screen or a touch pad. The method includes following steps:

Step 202: obtaining sliding track data generated by actions on a contact button in contact list by a mobile terminal.

In this embodiment, the sliding track data can be obtained directly, which are generated by actions on a contact button in the contact list and detected by the mobile terminal, and the sliding track data include multiple coordinate data aligned at intervals in the sliding track.

Step 204: obtaining the sliding distance according to the sliding track data by said mobile terminal.

Concretely, the sliding distance can be obtained according to the coordinate data contained in the sliding track data, and the sliding distance is the distance between the initial touch point and the terminal touch point.

Step 206, detecting if the interface is in the state which supports sliding operations by said mobile terminal, if it is, then turning to step 208, if not, then going to the end.

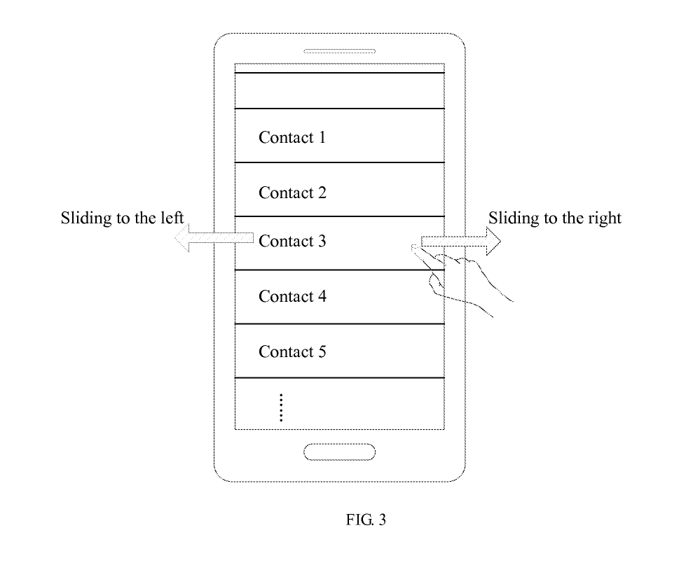

An operating interface for triggering a communication with a contact is shown in FIG. 3, wherein the contact list is displayed in the address book, the user can perform sliding operations in the touch screen using fingers. In this embodiment, the interface can be set to support sliding operations whenever contacts are located in the address book, and not support sliding operations whenever contacts are not located in the address book. For instance, the interface doesn't support sliding operations when the user clicks the contact button and accesses to the interface of contact details. The term “to support sliding operations” referred to in the present application means to support the operating instruction of sliding operations triggering a communication with a contact.

Step 208: judging if the sliding distance reaches the threshold by said mobile terminal, if it does, then turning to the step 210, if not, then going to the end.

In this embodiment, the threshold can be set as one half of the horizontal width of the display screen, the interface supports sliding operations when the sliding distance reaches this threshold, otherwise, the interface does not support sliding operations.

Step 210: identifying the direction of sliding track according to the sliding track data by said mobile terminal.

As mentioned above, the direction of sliding track can be identified according to the coordinate data contained in the sliding track data, and different directions trigger different operating instructions.

Step 212: triggering corresponding operating instruction according to the direction of sliding track by said mobile terminal, wherein, the operating instruction includes a dialing instruction for making a phone call to the contact and/or a short message instruction for sending a short message to the contact.

As shown in FIG. 3, the mobile terminal can detect the sliding signal with respect to the contact 3 generated by the user's finger, when it is identified that the direction is to the right, the dialing instruction is triggered to dial the contact number of the contact 3, when it is identified that the direction is to the left, the short message instruction is triggered to access to the short message editing interface with respect to the contact 3.

In one embodiment, prior to the step 212, an additional step can be performed to judge if the previous operating instruction has been executed by said mobile terminal, if it is, then turning to the step 212, if not, then not processing with respect to the identified direction of sliding track.

It should be explained that, although the embodiment shown in FIG. 2 adopts both of step 206 and step 208, it should be understood that, in this embodiment, at least one of the step 206 and the step 208 is necessarily adopted.

In this embodiment, quick dialing and quick sending a short message can be realized by means of different operating instructions with respect to the contact which are triggered by the direction of sliding track, such that, the operations are simplified and the duration time of the mobile terminal is prolonged. Moreover, by means of judging whether the sliding distance reaches the threshold and/or judging whether the interface is in the state which supports sliding operations, the probability of false operations is reduced. By means of judging whether the previous operating instruction has been executed, and allowing to trigger the operating instruction corresponding to the direction of sliding track only when the operating instruction has been executed, repeated sliding operations in the touch screen can be avoided, and the accuracy of the operation is improved.

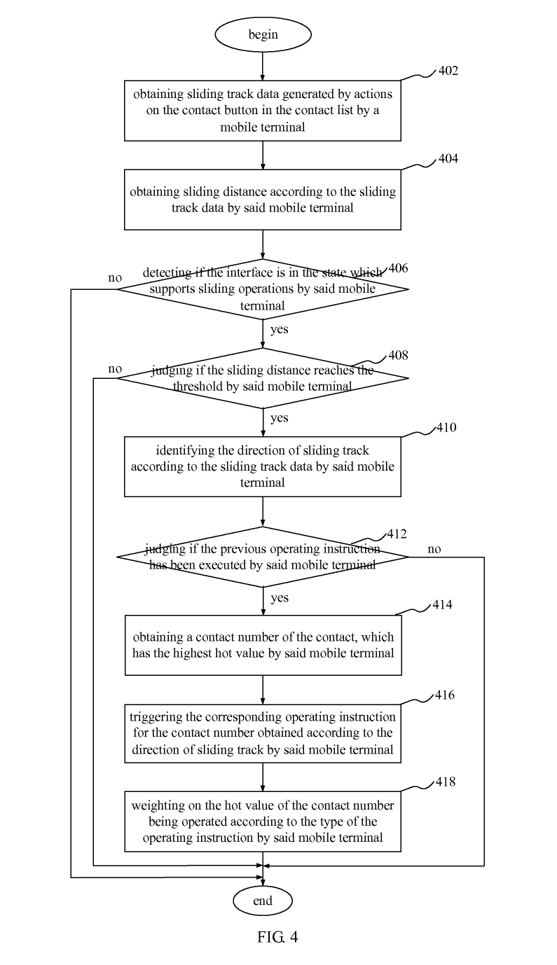

As shown in FIG. 4, in one embodiment, a method is provided for triggering a communication with a contact, which is also illustrated by implementing the method in the mobile terminal which has a communicating function and contains a touch screen or a touch pad. The method includes following steps:

Step 402: obtaining sliding track data generated by actions on the contact button in the contact list by a mobile terminal.

Step 404: obtaining sliding distance according to the sliding track data by said mobile terminal.

Step 406: detecting if the interface is in the state which supports sliding operations by said mobile terminal, if it is, then turning to the step 408, if not, then going to the end.

Step 408: judging if the sliding distance reaches the threshold by said mobile terminal, if it does, then turning to the step 410, if not, then going to the end.

Step 410: identifying the direction of sliding track according to the sliding track data by said mobile terminal.

Step 412: judging if the previous operating instruction has been executed by said mobile terminal, if it has, then turning to the step 414, if not, then going to the end.

Step 414: obtaining a contact number of the contact, which has the highest hot value by said mobile terminal.

The hot value of the contact number reflects the contacting frequency of this contact number, the higher the hot value is, the higher the contacting frequency of the contact number is. In this embodiment, weighted values can be assigned to different operations with respect to the contact number, the hot value of the contact number is calculated according to the weighted values, and the hot value of the contact number is added or deducted according to the time interval between two communications. For instance, with respect to the contact number A, three points are added for dialing one time, two points are added for sending one short message, and then the hot value of the contact number is 5 points; if there is no communication with respect to the contact number A in one day, then one point is deducted correspondingly.

Step 416: triggering the corresponding operating instruction for the contact number obtained according to the direction of sliding track by said mobile terminal.

Obtaining the contact number with the highest hot value, and then triggering the operating instruction for this contact number according to the direction of sliding track.

Step 418: weighting on the hot value of the contact number being operated according to the type of the operating instruction by said mobile terminal.

After triggering corresponding operating instruction for the contact number obtained, weighting on the hot value of this contact number according to the present operation so as to update the hot value of this contact number.

In this embodiment, quick dialing and quick sending a short message can be realized by means of different operating instructions with respect to the contact which are triggered by the direction of sliding track, such that, the operations are simplified and the duration time of the mobile terminal is prolonged. Moreover, by means of judging whether the sliding distance reaches the threshold and/or judging whether the interface is in the state which supports sliding operations, the probability of false operations is reduced. By means of judging whether the previous operating instruction has been executed, and allowing to trigger the operating instruction corresponding to the direction of sliding track only when the operating instruction has been executed, repeated sliding operations in the touch screen can be avoided, and the accuracy of the operation is improved. Quick communicating with the most frequently used contact number of the contact can be realized by means of triggering the corresponding contact number with the highest hot value, such that, the operations are further simplified and the duration time of the mobile terminal is further prolonged.

As shown in FIG. 5, in one embodiment, a device is provided for triggering a communication with a contact, the device includes:
a track obtaining module 520, used for obtaining sliding track data generated by actions on the contact button in the contact list;
a track identifying module 540, used for identifying the direction of sliding track according to the sliding track data;
an instruction triggering module 560, used for triggering a corresponding operating instruction according to the direction of sliding track, wherein, the operating instruction includes a dialing instruction for making a phone call to the contact and/or a short message instruction for sending a short message to the contact.

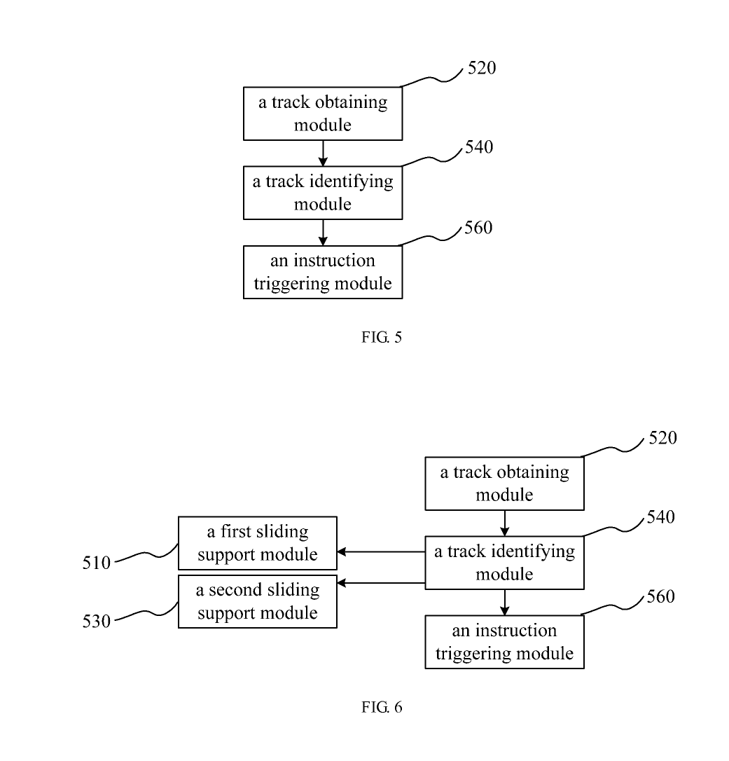

As shown in FIG. 6, in another embodiment, another device is provided for triggering a communication with a contact, on the basis of the embodiment shown in FIG. 5, the device further includes:
a first sliding support module 510, used for obtaining sliding instance according to the sliding track data, judging whether the sliding instance reaches the threshold, if it does, then notifying the track identifying module 540 to identify the direction of sliding track;
a second sliding support module 530, used for detecting whether the interface is in the state which supports sliding operations, if it is, then notifying the track identifying module 540 to identify the direction of sliding track.

In another embodiment, the device can further include either one of the first sliding support module 510 and the second sliding support module 530.

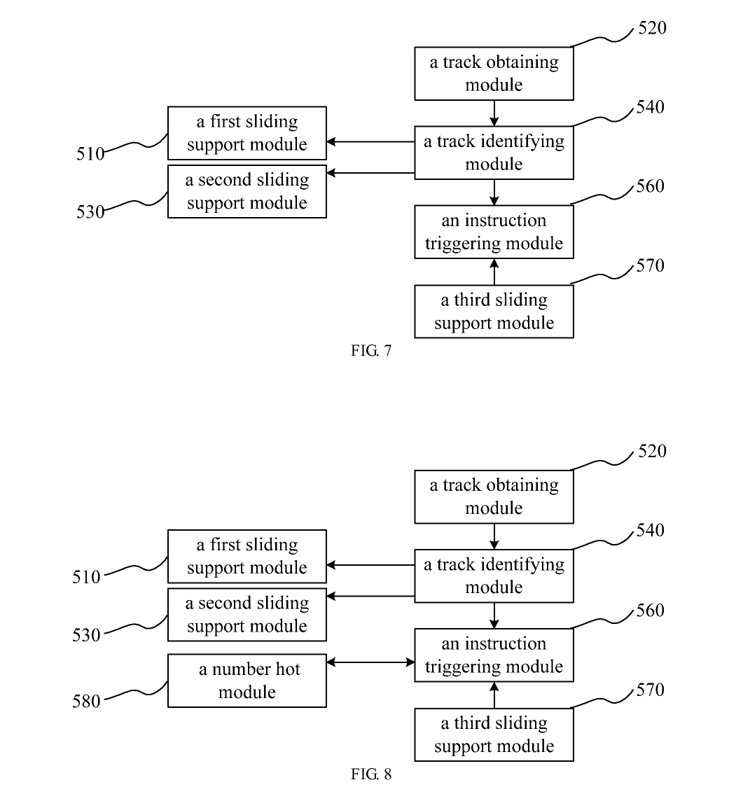

As shown in FIG. 7, in another embodiment, another device is provided for triggering a communication with a contact, on the basis of the embodiment shown in FIG. 6, the device further includes:
a third sliding support module 570, used for judging if the previous operating instruction has been executed, if it has, then notifying the instruction triggering module 560 to trigger the corresponding operating instruction, if not, then notifying the instruction triggering module 560 not to process with respect to the identified direction of sliding track.

As shown in FIG. 8, in another embodiment, another device is provided for triggering a communication with a contact, on the basis of the embodiment shown in FIG. 7, the device further includes a number hot module 580. In this embodiment, the instruction triggering module 560 is used for obtaining the contact number of the contact which has the highest hot value, and trigger corresponding operating instruction with respect to the contact number obtained. The number hot module 580 is used for weighting on the hot value of the contact number being operated according to the type of the operating instruction.

The device for triggering a communication with a contact mentioned above may be a mobile terminal, such as a mobile phone or a personal digital assistant or a computer for car. Wherein, the personal digital assistant is known as a handheld PC, which is a handheld terminal, such as a smart mobile phone or a panel PC or a handheld game machine, etc.

The ordinary technician in the field can understand that, all of or part of the processes implementing the methods of the embodiments mentioned above, may be achieved by means of relevant hardware commanded by computer programs, the computer programs may be stored in the computer readable storage medium, and it may include the processes of embodiments of the respective methods mentioned above when the program is executed. Wherein, the storage medium may be a disk or CD or read-only memory or random access memory, etc.

The foregoing examples are preferred embodiments of the present invention only and not intended to limit the present disclosure. It should be understood that, to the person skilled in the art, various modifications and improvements can be made without departing from the spirit and principle of the present disclosure, which should all be included within the scope of the present disclosure. Therefore, the protection scope of the present disclosure shall be defined by the appended claims.

1-23. (canceled)

24. A method for triggering a communication with a contact, comprising:
obtaining, by a mobile terminal, sliding track data generated by a sliding track action on a contact button of a user interface in a contact list by a mobile terminal;
obtaining, by the mobile terminal, a sliding distance according to the sliding track data and determining whether the sliding distance reaches a threshold; when the threshold is reached;
detecting, by the mobile terminal, whether the user interface is in a state that supports sliding operations, when sliding operations are supported, then identifying a direction of the sliding track according to the sliding track data; and
triggering a corresponding operating instruction according to the direction of the sliding track;
wherein the operating instruction includes a dialing instruction for making a phone call to the contact or a short message instruction for sending a short message to the contact.

25. The method for triggering a communication with the contact according to claim 24, wherein, prior to triggering corresponding operating instruction according to the direction of the sliding track by the mobile terminal, further comprises:
determining whether the direction of the sliding track was executed by the mobile terminal, when the direction of the sliding track was executed, then going to the step of triggering a corresponding operating instruction according to the direction of sliding track, when the direction of the sliding track was not executed, then not processing with respect to the direction of sliding track being identified.

26. The method for triggering a communication with a contact according to claim 24, wherein, the triggering the corresponding operating instruction according to the direction of the sliding track comprises:
when the direction of sliding track is in a first direction, then triggering, by the mobile terminal, a dialing instruction for making a phone call to the contact;
when the direction of the sliding track is in a second direction, then triggering, by the mobile terminal, a short message instruction for sending a short message to the contact;
wherein, the first direction is opposite to the second direction.

27. The method for triggering a communication with a contact according to claim 24, wherein the triggering the corresponding operating instruction according to the direction of the sliding track further comprises:
obtaining a contact number of the contact by the mobile terminal that has a highest hot value;
triggering a corresponding operating instruction with respect to the contact number obtained by the mobile terminal according to the direction of sliding track; and
weighting the hot value of the contact number by a predetermined amount according to the operating instruction triggered by the mobile terminal.

28. A device for triggering a communication with a contact, comprising:
a track obtaining module, configured to obtain sliding track data generated by actions on a contact button of a user interface in a contact list;
a track identifying module, configured to identify a direction of the sliding track according to the sliding track data;
an instruction triggering module, configured to trigger a corresponding operating instruction according to the direction of the sliding track;
a first sliding support module, configured to obtain a sliding distance according to the sliding track data, to determine whether the sliding instance reaches a threshold, when the threshold is reached, then to notify the track identifying module to identify the direction of sliding track; and
a second sliding support module, configured to detect whether the user interface is in a state that supports sliding operations, when the user interface is in a state that supports sliding operations, then notifying the track identifying module to identify the direction of sliding track;
wherein the operating instructions include a dialing instruction for making a phone call to the contact or for making a short message instruction for sending a short message to the contact.

29. The device for triggering a communication with a contact according to claim 28, further comprising:
a third sliding support module, configured to determine whether the direction of the sliding track was identified; when the direction of the sliding track was identified, then the third sliding support module is further configured to notify the instruction triggering module with the corresponding operating instruction, when the direction was not identified, then the third support module is configured to notify the instruction triggering module not to process the direction of sliding track.

30. The device for triggering a communication with a contact according to claim 28, wherein when the direction of the sliding track is in a first direction, the instruction triggering module is configured to trigger a dialing instruction for making a phone call to the contact; when the direction of the sliding track is in a second direction, the instruction triggering module is configured to trigger a short message instruction for sending a message to the contact;
wherein the first direction is opposite to the second direction.

31. The device for triggering a communication with a contact according to claim 28, wherein, the instruction triggering module is configured to obtain a contact number of the contact having a highest hot value, and to trigger the corresponding operating instruction with respect to the obtained contact number;
the device further comprises:
a hot number module, configured to weight the hot value of the contact number according to the operating instruction.

32. The device for triggering a communication with a contact according to claim 28, wherein the device for triggering a communication with a contact is a mobile terminal.

33. The device for triggering a communication with a contact according to claim 32, wherein the mobile terminal is a mobile phone or a personal digital assistant or a computer for a vehicle.

34. A non-transitory computer readable storage medium, including computer executable instructions, the computer executable instructions are used for executing a method for triggering a communication with a contact, wherein the method comprises:
obtaining, by a mobile terminal, sliding track data generated by user actions on a user interface contact button in a contact list;
obtaining, by the mobile terminal, a sliding distance according to the sliding track data by the mobile terminal, and determining whether the sliding distance reaches a threshold, when the threshold is reached, then identifying the direction of the sliding track according to the sliding track data;
detecting whether the user interface is in a state that supports sliding operations; when sliding operations are supported, then identifying a direction of the sliding track according to the sliding track data; and
triggering a corresponding operating instruction according to the direction of the sliding track;
wherein the operating instruction includes a dialing instruction for making a phone call to the contact or a short message instruction for sending a short message to the contact.

35. The non-transitory computer readable storage medium according to claim 34, wherein, prior to the step of triggering corresponding operating instruction according to the direction of the sliding track, further comprising :
determining whether the direction of the sliding track was identified, when the direction is identified, then turning to the step of triggering a corresponding operating instruction according to the direction of the sliding track, if the direction is not identified, then not processing the direction of sliding track.

36. The non-transitory computer readable storage medium according to claim 34, wherein the triggering corresponding operating instruction according to the direction of sliding track comprises:
when the direction of the sliding track is in a first direction, triggering a dialing instruction for making a phone call to the contact; and
when the direction of the sliding track is in a second direction, triggering a short message instruction for sending a short message to the contact;
wherein the first direction is opposite to the second direction.

37. The non-transitory computer readable storage medium according to claim 34, wherein, the triggering corresponding operating instruction according to the direction of the sliding track by the mobile terminal comprises:
obtaining a contact number of the contact by the mobile terminal that has the highest hot value;
triggering corresponding operating instruction with respect to the contact number obtained by the mobile terminal, according to the direction of sliding track; and
weighting the hot value of the contact number according to the corresponding operating instruction.

38. The method for triggering a communication with a contact according to claim 25, wherein the triggering corresponding operating instruction according to the direction of the sliding track comprises:
obtaining a contact number of the contact by the mobile terminal that has the highest hot value;
triggering a corresponding operating instruction with respect to the contact number obtained by the mobile terminal, according to the direction of sliding track; and
weighting the hot value of the contact number according to the corresponding operating instruction.

39. The method for triggering a communication with a contact according to claim 26, wherein the triggering corresponding operating instruction according to the direction of sliding track comprises:
obtaining a contact number of the contact by the mobile terminal that has the highest hot value;
triggering a corresponding operating instruction with respect to the contact number obtained by the mobile terminal, according to the direction of sliding track; and
weighting the hot value of the contact number operated according to the corresponding operating instruction.

40. The device for triggering a communication with a contact according to claim 29, wherein, the instruction triggering module is configured to obtain the contact's contact number having a highest hot value, and trigger a corresponding operating instruction with respect to the obtained contact number;
the device further comprises:
a hot number module configured to weight a hot value of the obtained contact number according to the corresponding operating instruction.

41. The device for triggering a communication with a contact according to claim 30, wherein, the instruction triggering module is configured to obtain the contact's contact number having a highest hot value, and trigger a corresponding operating instruction with respect to the obtained contact number;
the device further comprises:
a hot number module, configured to weight a hot value of the obtained contact number according to the corresponding operating instruction.

42. The non-transitory computer readable storage medium according to claim 35, wherein, triggering corresponding operating instruction according to the direction of sliding track comprises:
obtaining a contact number of the contact, by the mobile terminal that has a highest hot value;
triggering a corresponding operating instruction with respect to the contact number according to the direction of the sliding track; and
weighting a hot value of the contact number according to the corresponding operating instruction.

43. The non-transitory computer readable storage medium according to claim 36, wherein, triggering corresponding operating instruction according to the direction of the sliding track comprises:
obtaining a contact number of the contact that has a highest hot value;
triggering a corresponding operating instruction with respect to the obtained contact number according to the direction of the sliding track; and
weighting a hot value of the contact number according to the corresponding operating instruction.
